(19) United States
(12) Patent Application Publication
(10) Pub. No.: US 2016/0107472 A1
(43) Pub. Date: Apr. 21, 2016

(54) METHOD OF PROVIDING A SECURITY DOCUMENT WITH A SECURITY FEATURE, AND SECURITY DOCUMENT

(71) Applicant: FÁBRICA NACIONAL DE MONEDA Y TIMBRE - REAL CASA DE LA MONEDA, Madrid (ES)

(72) Inventors: Vicente GARCIA JUEZ, Madrid (ES); Javier GAMO ARANDA, Madrid (ES); Luis BORRUEL NAVARRO, Madrid (ES)

(21) Appl. No.: 14/895,205

(22) PCT Filed: Jun. 24, 2014
(86) PCT No.: PCT/EP2014/063267

§ 371 Date: Dec. 1, 2015

(30) Foreign Application Priority Data
Jun. 26, 2013 (EP) 13382249.4

(51) Int. Cl. B42D 25/351; G07D 7/12; B42D 25/45

(52) U.S. Cl. CPC B42D 25/351; B42D 25/45; G07D 7/124

(57) ABSTRACT

A method of providing a security document with a security feature includes the steps of providing a conductive layer, and removing part of the conductive layer to convert at least a portion of the conductive layer into a metamaterial. The metamaterial is selected to provide for authentication of the security document. It is possible to obtain a security document with this method and to subsequently authenticate the security document.

### TECHNICAL FIELD

The present disclosure is related to the field of security documents.

### BACKGROUND

Security documents, including value documents such as banknotes and cheques, and identity documents such as passports and identity cards, are frequently subjected to fraud. In order to increase security and to make forgery more difficult, security documents are frequently provided with so-called security elements, applied onto or inserted into said security documents. The security elements can, for example, provide controlled responses to external stimuli, and/or provide certain visual effects, thereby allowing for the verification of the authenticity of the document into which they have been incorporated.

The configuration, design and composition of a security element is often intended to remain unaltered once it has been incorporated into the security document, for example, applied to or inserted into a substrate of the security document, such as a paper substrate of the security document. Generally, the security element is intended to maintain its properties until the end of the life cycle of the security document, although sometimes alterations may occur due to, for example, wear and tear caused by the use of the document.

Security elements can be in the form of, for example, security threads or strips, luminescent fibres, iridescent strips or planchettes, holographic tags, patches or strips, solid microparticles, reactive chemical agents or printed security inks. It is known to place this kind of elements inside the paper substrate of a document or within the pulp from which the substrate is produced (this is often the case with security threads, strips, fibres, microparticles or reactive chemical agents) or on the surface of the substrate (this is often the case with patches, holographic strips, reactive chemical agents or printed strips). It is known to place security elements at specific positions of a substrate and/or in register with other security features of a substrate (this is frequently the case with security threads and strips, holographic strips, and printed inks), but security elements can also be distributed randomly on or in the substrate (this is often the case with fibres, solid microparticles, and reactive chemical agents).

The incorporation of the security elements into the security document contributes to making forgery more difficult in at least two different ways, namely: due to the difficulty of manufacturing the security elements; due to the difficulty of incorporating the element into the substrate (especially if placed in register with other features). The level of difficulty can be further enhanced if several security elements are incorporated in the same security document, and especially of they are placed very close to each other.

The position in register or the precise positioning of each security element in a substrate makes it possible to incorporate a relatively large amount of security elements in the substrate. On the contrary, when there are substantial tolerances in the positioning of a security element in a substrate, it may be necessary to increase the space between security elements so as to reduce the risk of non-desired interaction or overlapping between security elements; this implies a restriction on the amount of security elements that can be incorporated into and/or onto the substrate of the security document.

A large number of prior art references teach different aspects related to the incorporation of security threads or ribbons into paper substrates.

For example, GB-1095286-A discloses the use of thin security ribbons which are incorporated into a security paper. Said ribbons contain, before their incorporation into the paper, different graphical designs in the form of characters or symbols which can also be visually detected, through the use of lenses or microscopes, once incorporated into the paper.

WO-2004/050991-A1 discloses a method for manufacturing a security paper in which a security thread is partially embedded in such a way that there are areas of the said security thread which remain exposed. The holographic or metalized graphical motifs can thus be seen with the naked eye, in the same way in which they could be seen on the thread before it was inserted into the paper substrate. In addition, it is described that this thread will be positioned at a specific distance from (that is, in register with) a watermark, in order to facilitate the control of the position.

One problem frequently involved with the use of security threads is that the substrate is deformed by the security thread, as the presence of the security thread in the substrate increases the thickness of the substrate locally, as the thickness of the security thread is added to the thickness of the paper as such. This is the reason for why, in bank notes, the position of the security thread often varies between different individual bank notes of the same kind: frequently, the position of the security thread in the bank note, in the cross direction (that is, the direction perpendicular to the machine direction, which corresponds to the axial direction of the security thread), can vary several mm if different banknotes are compared. This prevents the increased thickness of the individual banknotes at the location of the security thread to accumulate and produce an excessive bulging of a stack of banknotes comprising a large number of superposed banknotes of the same kind.

However, this implies a difficulty when a certain security feature of a security thread, such as an image, symbol, marking, or other characteristic of the security thread, or the security thread itself, is to be placed in register with a security feature which forms part of the substrate of the document, such as an image, symbol or other mark printed on a paper substrate. For example, if an image printed on a security thread is to be placed in register with an image printed on a substrate into which the thread is to be inserted, this may be difficult or impossible if the position of the security thread is not the same in all substrates, such as, for example, in the paper substrates of a plurality of bank notes.

Also, when substrates for security documents are produced by cutting from a sheet or bobbin of the substrate material already containing the security thread (such as a sheet or web of paper or other cellulose based material), tolerances in the cutting process may affect the position of the security thread within the individual substrate, for example, in relation to the edge of the substrate. That is, if comparing a plurality of cut substrates, the security thread may not always be in the same position in relation to an edge or side of the substrate, for example, in the case of bank notes, typically in relation to one of the shorter sides, which often are parallel with the security thread.

Sometimes, an intended variation in the position of the security thread (for example, as in the case of banknotes, for the purpose of preventing all of the security threads from being exactly superimposed on top of each other when stacking banknotes, so as to prevent the stack from bulging excessively) can add up with a variation due to tolerances in the processes of insertion of the security threads into the substrates and/or cutting of the substrates, thereby giving rise to a substantial variability of the position of the security thread in relation to a reference point of a substrate, such as an edge of the substrate.

That is, to prevent the locally increased thickness of the substrate to accumulate excessively when many substrates are placed on top of each other, and in order to avoid the risk for “non-valid” substrates due to the tolerances in the insertion of the threads and/or cutting of the substrates from a large sheet or band, it is known to vary the position of the security thread in a controlled way within a predetermined interval, so that if comparing a number of substrates, the thread will not always be in the same position within the document (for example, in relation to an edge or side of the substrate or security document): the thread will be placed in a position that can vary within a given range, for example, with +/− a few millimeters from a reference position. However, this varying position of the thread may raise doubts with regard to the validity or authenticity of the document, for example, when a layman examines two banknotes and observes that the security threads are not placed in the same position.

Also, as indicated above, a further problem involved with a lack of register between a security element and a substrate is that it restricts the possibility of adding further security elements, due to the risk of interference between different security elements when they are very near each other of when they overlap each other.

EP-1872965-A1 teaches a security thread, strip or band comprising a cellulose support which can act as a carrier for security elements such as pigments, synthetic elements and/or security fibers, and which can be inserted into a paper substrate, whereby the cellulose substrate of the security strip can be completely integrated in the paper pulp, although without disappearing as an independent element. The fact that both the substrate of the security strip as the paper substrate into which it is integrated, that is, the substrate of the security document, to a substantial extent are made up of cellulose fibres, facilitates the integration between the substrate of the security document (hereinafter also referred to as the “document substrate”) and the substrate of the security element (hereinafter also referred to as the “document substrate”). Due to this integration, such a cellulose strip does not contribute to an increase in the thickness of the document substrate in the same way as, for example, a metal or plastic strip. The strip can be provided with detectable symbols or other security features.

A known way of arranging a security feature of a security element in register with a substrate includes forcing, in a controlled manner, the variation of the visual appearance of the security element after it has been applied to the substrate.

For instance, US-2008/0191462-A1 discloses a security document with a paper substrate, having a coating on a portion of its surface. The coating includes a metallic layer which is modified by laser light, thereby marking the coating. This marking can be made in register with markings on the paper outside the coating, as shown in US-2008/0191462-A1. However, a problem with this method is that the marking is carried out on the surface of the document, wherefore the marked portions can easily be subjected to wear and degradation during use of the document, which can lead to doubts about its authenticity. Also, superficial markings can sometimes be subjected to fraudulent alterations.

The use of laser light for producing security features in security documents or elements is well known in the art.

For example, US-2010/0164217 teaches a method for manufacturing a security feature for a security element, a security paper or a data carrier that exhibits a substrate into which at least one through opening and at least one marking in register with the through opening are to be introduced.

US-2010/0272313-A1 teaches a forgery prevention medium that includes a volume hologram layer on which an interference pattern is recorded after being exposed to at least an emitted laser beam; a digital watermarking information layer on which digital watermarking information is recorded; and a substrate film.

WO-2009/106066-A1 discloses a security document including a layer with components sensitive to a laser light source, allowing for laser marking of the document.

JP-2005-279940-A discloses a printable security sheet, comprising a multilayer paper structure with an inner resin layer which can be altered by laser light.

US-2005/0142342-A1 discloses a process to increase the security level of paper documents. Applied to the paper document is a transfer film or laminating film having a laser-sensitive layer, and a laser-induced marking is produced in the laser-sensitive layer, for example, by laser-induced bleaching, laser-induced colour change or laser-induced blackening. It is taught that respective individualization of the document can be effected by way of that laser-induced marking.

US-2008/0187851-A1 discloses the marking of a material with identifier marks. An optical brightener is incorporated in the material, and marking is performed by reducing the brightness of the material at a selected location by directing local heating to this location, the mark thus produced appearing with a darker shade than its environment in ultraviolet light. The marking is based on partial or complete destruction of the brightening effect of the optical brightener under heating. The disclosure is suitable for providing e. g. coated paper and board containing an optical brightener with identifier marks for preventing falsifications.

WO-02/101147-A1 discloses a security thread with an opaque layer on which signs, figures or characters have been generated by means of a laser light, before the insertion of the security thread into a paper substrate.

EP-1291827-B1 discloses a method for the customization of security documents on the surface of which there are superimposed materials which have different resistances to laser light. These materials are treated with laser light, producing a marking.

EP-2284015-B1 discloses a security element having a reflective layer which, by means of laser radiation, is marked with visually perceptible marks in the shape of patterns, letters, numbers or images.

EP-2271501-B1 teaches laser treatment of security documents involving perforation and simultaneous marking using a laser. A paper substrate has a marking region with a laser sensitive substance, and a security element is present in the marking region. The security element is weakened by laser light in order to generate, simultaneously and at perfect register, weak lines in the security element and marks in the paper substrate by alteration of the sensitive substance.

WO-2013/037473-A1 teaches marking of the front and/or rear surface of a substrate, or of the interior of a substrate, with laser light. The surface of a cylinder which is in contact with the substrate is arranged to take up ablated particles, so that these ablated particles do not adhere to the substrate or a following substrate.

On the other hand, WO-2008/110775-A1 teaches a security mark comprising a metamaterial such that properties of the metamaterial provide authentication of the security mark. This kind of mark can be detected by using an infrared (IR) or a terahertz radiation source. Metamaterials typically include patterns of conductive materials such as arrays of sub-wavelength holes as taught by W. Zhang, “Resonant terahertz transmission in plasmonic arrays of subwaelength holes”, Eur. Phys. J. Appl. Phys. 43, 1-18 (2008) and T. W. Ebbesen et al., “Extraordinary optical transmission through sub-wavelength hole arrays”, Nature, Vol. 391, pages 667-669 (12 Feb. 1998), or other artificial media structured on a size smaller than wavelength of external stimuli. Their application in sensing is discussed by Tao Chen, et al., “Metamaterials Application in Sensing”, Sensors 2012, 12, 2742-2765.

US-2012/015118-A1 discloses a method and device for changing the color of a metal surface in a given part of the electromagnetic spectrum, by creating a surface relief as an array of raised or indented repeated elements without breaking the continuity of the metal surface.

DE-102004043064-A1 relates to security elements for security papers, value documents, etc., with a machine-readable authenticity feature that includes at least one area with a periodic conductive surface element featuring resonance effects when subjected to electromagnetic radiation within a predetermined frequency range.

EP-2138322-A2 teaches a value or security document with at least one structural element for forming a metamaterial.

WO-2012/094436-A2 relates to electronic components on paper-based substrates. Reference is made to patterned conductive structures and to special effects at different frequencies, including the Teraherz range.

WO-2004/081545-A1 discloses a security label which is optically read by Terahertz radiation.

### SUMMARY

A first aspect of the disclosure relates to a method of providing a security document with a security feature, comprising the step of providing a conductive layer, and the step of removing part of said conductive layer so as to convert said conductive layer, or a part or a portion thereof, into a metamaterial selected or arranged to provide for authentication of the security document. Thereby, a metamaterial is provided that can provide authentication of the security document. That is, the metamaterial can be provided merely by removing part of the conductive layer, for example, by removing said part of said conductive layer so as to leave parts of said conductive layer separated from other parts of said conductive layer, or by removing said part of said conductive layer so as to form openings (that is, through holes) in said conductive layer. The removal can be selected so as to customize the security document, by providing a pre-selected response to a certain kind of radiation.

The metamaterial obtained in this way can comprise a substantially bi-dimensional matrix of conductive material, a matrix based on the repetition of a base cell in rows and columns. In some embodiments of the disclosure, the metamaterial is provided to provide a characteristic response to radiation, such as radiation in the Terahertz (THz, i.e., 10¹² Hz) range. The characteristic response can be in the form of electromagnetic resonance peaks, extra-ordinary transmission in the THz range, polarization effects, etc. For example, extra-ordinary optical transmission (EOT) is a phenomenon of greatly enhanced transmission of light through sub-wavelength apertures in an otherwise opaque metallic film, which has been patterned with a regularly repetitive periodic structure, such as with sub-wavelength openings. The phenomenon has been attributed to the presence of surface plasmon resonances and constructive interference. EOT can be used for authentication of security documents by irradiating the metamaterial with radiation in the THz range and detecting the radiation by sensors or detectors placed on the other side of the security document, or using reflection and sensors placed on the same side of the security document as the source of the radiation. Also, this kind of equipment can be used to verify a correct response of the metamaterial to radiation during production of the security document, that is, by testing the response of the metamaterial once it has been established by the removal of part of the conductive layer.

In some embodiments of the disclosure, the conductive layer can be applied onto a security element substrate such as a strip or patch, for example, before inserting the security element substrate into a security document substrate. In some embodiments of the disclosure, the conductive layer is applied to the surface of a security document substrate, such as onto a surface of a security paper. Any suitable conductive layer can be used. For example, a metal layer, or a metal oxide layer, or a layer of one or more conductive polymers such as polyanilin, poly(ethylenedioxythiophene) PEDOT, 3,4-ethylenedioxythiophene or poly(3,4-ethylenedioxythiophene) poly(styrenesulfonate). The conductive layer can be applied by, for example, printing or metallization techniques conventionally used in the art. In some embodiments of the disclosure, the conductive layer is less than 5 μm thick, and in some embodiments of the disclosure the optical density of the conductive layer is in the range of 1.2-2.6.

In some embodiments of the disclosure, the metamaterial is used to customize the security document. In some embodiments of the disclosure, the metamaterial may be selected to identify an owner of the security document. For example, the metamaterial can correspond to the name of the owner, or an image of the owner, or a code indicative of biometric data of the owner, etc.

In some embodiments of the disclosure, said part of said conductive layer is removed using laser light, for example, by sublimation or perforation. In this way, the conductive layer, such as a layer comprising metal and/or metal oxide or oxides and/or one or more conductive material such as conductive polymers, can be removed in part, in a controlled manner, and the way in which it is removed can be easily controlled and adapted by adapting the software controlling the way in which the laser light is applied onto the conductive layer. For example, subsequent security documents can be marked with different markings, and/or the markings can be used to personalize the security document, for example, with details relating to the holder of the security document. Also, the use of laser has been found to be appropriate to remove conductive material, such as metal or metal oxides, also within a security document, for example, forming part of a security element embedded in a paper substrate of the security document. Thus, use of laser light for removing part of the conductive layer to create a metamaterial provides for flexibility and a large number of possibilities in what regards at what stage of manufacture of the security document the metamaterial is created. In some embodiments of the disclosure, only the conductive layer is partially removed, for example by sublimation, but in other embodiments of the disclosure also the underlying substrate can be perforated, for example, creating openings that provide for enhanced capillarity.

In some embodiments of the disclosure, said part of said conductive layer is removed mechanically, for example, by punching, stamping, or similar. Punching or stamping may imply less flexibility than the use of laser light, but can be appropriate for many practical implementations. In some embodiments of the disclosure, said part of said conductive layer is removed chemically; chemical removal can be especially appropriate when the conductive layer has been applied by metallization. For example, chemical removal can be performed by printing processes using an ink based on NaOH, which dissolves the metal, such as aluminium, where the ink is applied onto the metal layer. This process can generally only be carried out before inserting the security element into a paper document substrate.

In some embodiments of the disclosure, said conductive layer is applied to a security element substrate, and the security element substrate is thereafter embedded in a security document substrate. Thereby, the metamaterial can be integrated within the security document substrate, whereby it will be better protected against wear and manipulation.

In some embodiments of the disclosure, said part of said conductive layer is removed after that said security element substrate has been embedded, for example, totally embedded or partially embedded with parts of said security element substrate visible through windows in said security document substrate. Thereby, the metamaterial is created after that the security element substrate or the security element has been embedded in the security document substrate. This can be advantageous, as it allows, for example, customization of an already produced security document substrate or security document. In some embodiments of the disclosure, this can be done without perforating the security document substrate. In some embodiments of the disclosure, it is preferred that no holes or similar should be burnt in the document substrate due to laser light used to remove the part of the conductive layer, and the document substrate should preferably not be marked or substantially marked by said laser light.

By means of the removal of part of the conductive layer with laser light, the properties of the security element can be altered after insertion of the security element into the substrate of the security document, such as a paper document substrate. That is, the security document can be provided with the metamaterial by directing laser light onto it and, more specifically, onto the document substrate and onto the conductive material embedded therein. This has been found to involve important advantages. For example, it allows customization of a security document by marking the security element, for example, with a name, identity number, serial number, code, or other symbols or marks, after incorporation of the security element into the paper substrate of the security document. Thus, the paper substrate can be produced incorporating the security element, for example, at the paper manufacturers premises, and customization of the security element can be carried out at a later stage, using laser light. For example, a passport can be customized with the details of the owner when being issued, and banknotes can be customized by not only printing the serial number on the surface of the paper, but also—or alternatively—by marking the security element, such as a security band or strip embedded within the substrate of the banknote, with said serial number and/or with the metamaterial indicative of, for example, said serial number. This marking can take place at any stage of the process of manufacturing and editing/processing the security document, for example, during the manufacture of the paper document substrate with the security element embedded therein, or immediately or shortly after manufacture of the document substrate, and/or at a later stage, for example, before printing of the document substrate and/or during printing thereof and/or once the document substrate has been printed, and/or once it has been further adapted to form part of a security document, such as a passport blank or similar. That is, the marking can take place at any stage, from the moment at which the security element has been embedded in the document substrate until the final issuing of a security document such as a passport, and even at later stages. For example, a security document can be updated during its lifetime by adding further laser markings by removing part of the conductive layer, and/or by creating additional metamaterial portions by removing part of the conductive layer.

A further advantage is that the marking of the security element can be carried out in register with the document substrate, for example, so that the marking of the security element (for example, with a metamaterial) is positioned in a pre-determined relation with a feature of the document substrate, such as a watermark within the document substrate, a printed marking on the surface of the document substrate—such as a portion of an image printed on the document substrate—, or a side or edge of the document substrate. This can be advantageous, as it allows the marking of the security element to be placed in a very specific position in relation to the document substrate, independently of the tolerances involved with the placement of the security element as such within the document substrate, as long as this is possible in view of the dimensions of the security element, such as the width of a security band.

The presence of the marked security element within the document substrate can be advantageous to protect the security element from wear and to make forgery more difficult.

The possibility of ensuring that the security marking such as a metamaterial is in register with the document substrate makes it possible to optimize the incorporation of further security features and elements into or onto the document substrate, without risking a non-desired interaction with the security marking of the security element, for example, due to accidental overlapping.

Also, ensuring that the security marking of the security element is in perfect or quasi perfect register with certain features of the substrate, such as printed markings or watermarks, can help to prevent doubts about the authenticity of the security document.

The marking of the security element can thus include partial removal of the layer of conductive material to create the metamaterial, but it can additionally also include adding other markings to the security element, for example, by removing parts of the conductive material to form symbols or codes, such as barcodes or QR dot codes. Obviously, in addition to the marking made after insertion of the security element into the document substrate, the security element may also comprise further security markings or security features, established prior to insertion of the security element into the document substrate.

It has been found that it is possible to make markings in a security element also after that it has been inserted or embedded into a paper substrate, for example, by removal, for example, by sublimation or ablation of metal or other materials forming part of the security element, for example, in the form of one or more layers on or in a non-metallic substrate. It has been found that this can be achieved without damaging or substantially damaging the paper document substrate. Different materials tend to absorb light or radiation differently, depending on the wavelength of the light or radiation. Thus, for example, a material forming part of the security element, for example, as a conductive layer of the security element, can easily be ablated or sublimated by laser light without damaging the surrounding paper document substrate, if the material has a high absorbance of laser light at a wavelength substantially different from the wavelength(s) at which the paper substrate (substantially comprising carbon atoms) has a high absorbance. Thus, by adequately selecting materials and wavelengths, removal of the conductive material can be achieved, for example by sublimation or ablation, without substantially damaging the paper document substrate. Thus, the laser can sublimate the material, such as metal, and thus eliminate part of the material originally part of the security element, such as a metal layer, without substantially affecting the paper document substrate and also without substantially affecting the substrate of the security element, which in some embodiments of the disclosure is also a paper substrate, or another kind of cellulose based substrate. The extent of the removal, for example, by sublimation or ablation, can depend on the way in which the laser is applied and also on the way in which the security element comprises the material, such as metal particles and/or a metal layer, and also on the characteristics of the paper document substrate and on the characteristics of the element substrate. However, the skilled person will not have any difficulties in tuning the laser treatment so as to achieve a desired marking of the security element, a marking that can be detected, for example, visually, by other optical means, magnetically, electromagnetically, or in any other way. For example, the marking can reside in leaving certain areas of the security element without the originally present metallization, thereby giving rise to a metamaterial that can be detected using radiation in the Terahertz range (also known as T-rays).

In some embodiments of the disclosure, said part of said conductive layer is removed before said security element substrate has been embedded in said security document substrate. That is, the metamaterial can be provided before the security element is added to the document substrate, for example, at the premises of an entity in charge of producing security elements. In some embodiments of the disclosure, the removal of part of the conductive layer can be carried out to enhance capillarity. For example, removal of part of the conductive layer can involve the perforation of the security element including the conductive layer and the security element substrate, thereby enhancing capillarity, which can be useful to improve integration between the security element and the document substrate, such as a paper document substrate.

In some embodiments of the disclosure, the method comprises the step of producing perforations or microperforations in the conductive layer and, optionally, also in an element substrate, after incorporation of said conductive layer onto or into said element substrate but prior to embedding the security element in a document substrate. This can be useful for establishing an adequate capillarity of the security element, thereby improving its integration with the paper document substrate. The perforations can be produced using laser light, so as to sublimate the conductive layer and, optionally, also the element substrate (such as a cellulose substrate, to be described below) containing and/or carrying said conductive layer, thereby completely perforating the security element and, thus, improving its capacity of becoming integrated with the paper document substrate. A suitable laser source can be one of the following ones: Fiber laser; Nd:YAG; Ho:YAG; Er:YAG; Tm:YAG; Organic dye; Excimer; and CO₂. Fibre laser, Nd:YAG and CO₂ are considered preferable. Wavelengths in the range of 100-11000 nm are preferred, and wavelengths in the range of 1000-11000 nm are more preferred. The laser spot diameter can typically be in the range of 0.01-1.000 mm, preferably 0.01-0.1 mm. The pulses can preferably have a duration in the range of femtoseconds to microseconds, more preferably in the range of nanoseconds to microseconds. The duration influences the thermal impact. The average power of the laser, which influences the perforation speed, can preferably be in the range of 100-2000 W, more preferably in the range of 125-250 W.

In some embodiments of the disclosure, the security element substrate comprises or is shaped as a strip or patch, preferably including paper, cellophane, polyester, propylene, or polycarbonate. That is, conventional kinds of security elements or security element substrates can be used as carriers or supports for the metamaterial. These security elements or element substrates can be completely or partially embedded in a document substrate, such as paper document substrates.

The security element can have a substantially laminar structure, which can be continuous or with perforations, such as microperforations. The security element can be prepared starting with a laminar cellulose structure in the form of a web or sheet, which after being provided with the appropriate characteristics (for example, the conductive layer, any microperforations, etc., as described above) is cut into strips or patches having an appropriate width.

In some embodiments of the disclosure, the security element comprises (or the element substrate is) a cellulose substrate (for example, the security element can comprise a substrate in the form of a cellulose support web in line with the one disclosed in EP-1872965-A1), preferably a paper or cellophane substrate. An advantage involved with a cellulose substrate, that is, a substrate based on cellulose fibres, is that it tends to integrate well with the paper document substrate into which it is to be embedded, as explained in EP-1872965-A1. This can serve to reduce the thickness of the document substrate at the position of the security element, and can further make it more difficult to remove the security element without damaging the security document. It also contributes to make it possible to use security elements having fairly large dimensions, such as a fairly wide security strip or band, such as a strip having a width in the range of 5-250 mm, without jeopardizing the integrity of the paper document substrate into which the security element is embedded. The cellulose material of the cellulose substrate can comprise cellulose fibres of vegetal origin which have been processed by physical processes, such as the ones used to manufacture paper, or which have been processed by chemical processes, such as the ones used to manufacture cellulose acetate or cellophane.

In some embodiments of the disclosure, the cellulose element substrate is a paper based substrate that has been manufactured with wet strength resin in its pulp, to prevent the cellulose substrate from disintegrating when inserted into the document substrate, for example, when inserted between two wet paper layers, for example, two wet paper layers coming from respective cylindrical wire meshes of a paper making machine. The water contained in said layers tends to destroy the hydrogen bonds between the cellulose fibers, but not the covalent bonds between the wet strength resin and the cellulose fibres. It can be preferred that the cellulose element substrate contains only relatively small amounts of wet strength resin, just enough to prevent the cellulose element substrate from disintegrating or breaking during its insertion between the two wet paper layers.

The cellulose element substrate is preferably porous or very porous, with capillarity that facilitates the penetration into the cellulose element substrate of the liquid contained in the paper layers between which the cellulose element substrate is to be embedded. As the document substrate will also generally be manufactured with wet strength resin in the pulp, due to the capillarity of the cellulose element substrate, the fluids present in the wet layers of the document substrate, which contain such wet strength resin, can enter into the cellulose element substrate. The fact that the cellulose element substrate contains only relatively small amounts of wet strength resin implies that the cellulose fibres retain the capacity of creating new chemical covalent bonds with the wet strength resin originating from the pulp of the paper layers of the document substrate. Due to this capacity, and due to the infiltration of additional wet strength resin from the wet paper layers, new covalent bonds are created between the cellulose fibres of the element substrate and the wet strength resin contained in the wet layers, after inserting the element substrate, when the wet strength resin is cured or activated during the process of drying the paper. This provides for an enhanced integration of the element substrate with the document substrate.

When the security element comprises a cellulose paper substrate, this substrate can be obtained through conventional paper manufacturing processes, in which vegetable-origin cellulose paper fibres are mechanically processed in order to form a cellulose pulp, and in which chemical agents, dyes and mineral fillers are added to said pulp, whereafter the pulp is subjected to sheet forming, pressing and drying processes in paper machines, followed by sizing to achieve a desired printing capacity. Preferably, to allow for an adequate integration of the element substrate in the paper document substrate, the element substrate made out of cellulose should have certain characteristics, such as the following ones:

The width of the element substrate, which can influence its capacity of being embedded, can typically be in the range of 5-250 mm, preferably 10-35 mm.

The thickness of the element substrate may also affect its capacity of becoming embedded. A suitable thickness can be in the range of 33-66 microns, preferably 44-55 microns.

A good capillarity can be preferred. For example, the element substrate can preferably feature a Bendtsen porosity (×4 sheets) >2000 ml/minute, preferably >2500 ml/minute.

For embedding purposes, a basis weight of the element substrate of 15-30 g/m² can be preferred, and a basis weight of 20-25 g/m² can be more preferred, especially when the document substrate has a basis weight in the range of 70-110 g/m²; this is considered to provide for a suitable capillarity in the case of cellulose substrates, and a suitable proportionality to the thickness of the document substrate.

In spite of the fairly low thickness and basis weight of the element substrate, the tensile strength of the element substrate should be adequate in order to avoid breaks during embedding. It is considered that adequate values may be in the following ranges:

Dry Tensile Strength:
Machine direction (MD): 20-35 N/15 mm, preferably 25-30 N/15 mm
Cross direction (CD): 8-25 N/15 mm, preferably 10-20 N/15 mm

Wet Tensile Strength:
Machine direction (MD): 0-5 N/15 mm (or 0.1-5 N/15 mm), preferably 0-2 N/15 mm (or 0.1-2 N/15 mm)

A low wet tensile strength can be useful to improve or facilitate the adaptation of the cellulose fibres of the element substrate to the layers of the paper document substrate into which the element substrate is to be embedded. For example, a cellulose element substrate can include a rather small proportion of wet strength resins, just enough to prevent the substrate from disintegrating when embedded between wet paper layers coming from the papermaking machine. During the process of embedding, when the element substrate meets the layers that form the paper document substrate, or the layers that when joined will form the paper document substrate, these layers still contain substantial amounts of water in the area where the element substrate meets the paper layers. Also, the wet strength resins contained in said layers (and that generally enhance the wet tensile strength) have not yet been activated, as the paper layers recently formed on the cylindrical wire meshes have not yet been subjected to the pressing and drying steps. At this stage, the porosity and capillarity of the element substrate provide for improved penetration into said substrate of the liquids contained in the wet paper layers, including the wet strength resins of said paper layers. This helps to enhance integration between the paper document substrate and the element substrate.

When the element substrate is a cellophane or cellulose acetate substrate, it can be obtained through conventional cellophane or cellulose acetate film manufacturing processes, in which cellulose fibres of vegetal origin are treated with acetic acid and anhydride in order to form a tri-acetate pulp which turns into cellulose acetate after a partial hydrolysis of the tri-acetate suspended in an aqueous acid solution. During a drying process, the cellulose acetate granulates. Finally, the granules are heated to melt and then laminated, thus obtaining a transparent laminar film, which is water-permeable, flexible and not thermoplastic. Such a laminar film can be useful as an element substrate to be embedded in a paper document substrate, for example, in the form of a security strip or band.

For compatibility with the insertion process, it is considered to be appropriate that the cellophane-based element substrate has the following features:

A width in the range of 5-250 mm, preferably 10-35 mm.

A thickness in the range of 10-40 microns, preferably 15-25 microns.

A dry tensile strength as follows:
MD: 20-35N/15 mm, preferably 25-30 N/15 mm
CD: 8-25 N/15 mm, preferably 10-20N/15 mm
The conductive layer can preferably be in the form of particles, such as metal particles, which can be added to in the mass and/or onto the surface of the element substrate.

In the case of a cellulose paper element substrate, the particles can, for example, be added at the stage in which the mineral fillers are added.

In the case of a cellophane or cellulose acetate substrate, the particles can, for example, be added once the acetate granules have been obtained, and mixed with the granules during the process.

In both cases, incorporation of the particles onto one or both of the surfaces of the element substrate can be achieved by, for example, printing processes which include these metallic particles, or, in the case of metal or metallic particles, by metallization processes with vacuum deposition.

The particles should have an adequate sublimation capacity. For example, metals and metal oxides can be used, preferably but not exclusively aluminium, nickel, copper, iron, tungsten or cobalt. Also conductive polymers, such as polyaniline, can be used.

If a printing process is used, the following parameters may be preferred:

Carrier (the choice of carrier influences the printing quality and the anchoring of the metal particles to the substrate): opaque and reflective ink.

Printing technique (the choice of printing technique can influence the distribution and thickness of the printed layer): heliogravure, silkscreen, offset; heliogravure may be the most preferred one.

The thickness of the printed layer (this influences the volume of the applied particles): 0.1-5 microns, more preferably 0.5-1 micron.

Linework (the choice of which influences the distribution and thickness of the printed layer): 10-80 lines/cm, more preferably 24-32 lines/cm.

Also, conventional metallization processes can be used.

The use of a cellulose based element substrate, such as a paper or cellophane/cellulose acetate substrate, involves advantages over the traditional metal or polymer (such as polyester or polypropylene) substrates, due to the chemical compatibility with the paper document substrate. However, when metallic particles or other particles are incorporated onto the surfaces and/or into the cellulose based substrates, the capillarity can be reduced, which may negatively affect the way in which the element substrate will be embedded in and integrated with the paper document substrate. In order to maintain or restore, as far as possible, an adequate level of capillarity so as to promote a correct embedding, it can be preferred to carry out a perforation or micro-perforation of the element substrate once the particles of the material that is sensitive to laser light have been incorporated, as described above. If desired, these microperforations can be made so small that they will not be visible to the naked eye, neither by reflection nor by transmission. These microperforations, for example, regularly spaced holes or openings, such as circular or elliptical ones, can contribute to establish the metamaterial.

In some embodiments of the disclosure, the security element substrate is a polymer strip, which preferably has a width of 1-5 mm, more preferably 2-4 mm, and a thickness of preferably 10-40 μm, more preferably 20-30 μm. For good adaptation to any deformations in the document substrate into which it is to be inserted, a tensile strength of 0.2-1.8 KgF can be preferred, and a tensile strength of 0.5-1.6 KgF can be more preferred, and an elongation of 65-250% can be preferred, whereas an elongation of 90-200% can be more preferred. The contact angle for insertion into a paper substrate is preferably in the range of 70°-110°, more preferably 85°-100°.

In some embodiments of the disclosure, the strip is a polymer strip applied as a security foil on a security document substrate, such as a paper document substrate. In these cases, the strip preferably has a width in the range of 5-50 mm, more preferably in the range of 8-20 mm, and a thickness in the range of 10-50 μm, more preferably 25-35 μm. A tensile strength of 0.2-1.8 KgF can be preferred and a tensile strength of 0.5-1.6 KgF can be more preferred, and an elongation of 50-100% can be preferred, 70-80% more preferred.

In some embodiments of the disclosure, the conductive layer is applied onto a security document substrate, whereafter said part of said conductive layer is removed. That is, the conductive layer can be applied to the document substrate, such as to a surface of the document substrate, such as onto a surface of a paper document substrate, so that a superficially located metamaterial is obtained. A paper document substrate can be appropriate for many practical applications, such as passports, banknotes, etc., and it can be advantageous when it is intended to create the metamaterial within the substrate, as explained above, in that paper allows for the sublimation of conductive material such as metal or metallic particles, without damaging the paper as such.

When the document substrate is a paper substrate and the security element comprises a cellulose element substrate, the document substrate can preferably feature certain parameters to facilitate an appropriate embedding of the cellulose security element. The document substrate can, for example, have a basis weight of 70-110 g/m², more preferably 80-90 g/m², and a thickness of 85-132 microns, more preferably 96-108 microns. For enhanced optical visibility, the opacity of the document substrate can preferably be in the range of 80%-98%, more preferably 90%-94%. The paper of the document substrate can preferably be made up of 2-4 layers, more preferably 2 layers, whereby the security element can be inserted between two of these layers. The paper manufacturing speed, which will affect the tension on the element substrate during insertion of the element substrate into the document substrate, can for example be in the order of 40-100 m/minute, more preferably 50-65 m/minute. Insertion of a cellulose security strip into a paper substrate is discussed in EP-1872965-A1, and the teachings of this document can be applied to the present disclosure.

Under these conditions, it is possible to guarantee a suitable insertion of the cellulose strip between two paper layers that will form the document substrate, at a moment when the respective paper layers are already formed and heading to the pressing and drying processes, leaving the wire meshes of the paper machine. In this way, the cellulose strip will become integrated in the document substrate without producing a substantial increase in the thickness of the document substrate where the element substrate is positioned, due to the physical-chemical interactions generated between the document substrate and the element substrate, which are basically due to the capillarity of the cellulose element substrate. However, despite this substantial integration, both the document substrate and the element substrate remain as different physical entities, that is, the element substrate does not generally “disintegrate” and disappear within the document substrate, and it can be observed as a substantially independent element in, for example, a cross-section of the document substrate.

This is a difference if compared to conventional security threads of, for example, synthetic polymeric substrates such as polyester or polypropylene substrates, which are generally non-porous and impervious and lack capillarity; thus, such substrates will not become integrated with the cellulose of the document substrate. When a conventional impervious security strip is inserted into the paper document substrate during its manufacture, the cellulose fibres of the document substrate simply accumulate above and below the security strip, which implies that the thickness of the document substrate will be increased at the position of the security strip: there is no integration between the security strip and the document substrate, but a mere yuxtaposition of the cellulose of the document substrate and the material of the security strip. This is the reason for why, in the manufacture of substrates that will be stacked on each other when in use, such as for example in the manufacture of substrates for banknotes, the security strip is generally fed so that its position in the cross direction will be different in different substrates, whereby the security strip will not be in register with, for example, the lateral edges or the print of the banknote, that is, the relation between the position of the security strip and, for example, an edge of the banknote, or a printed element on the banknote, or a watermark in the banknote, will not be the same for all banknotes of the same kind. Also this drawback can be avoided when using a cellulose substrate for the security element.

Also, as the cellulose security element does not substantially add to the thickness of the document substrate in the area in which the security element is present in the document substrate, the document substrate can be processed, such as printed and cut, just as if the security element had not been incorporated. This simplifies the production of the final security document.

In some embodiments of the disclosure, the element substrate can include, on one or both of its surfaces, either continuously or discontinuously, overlapping or not with those areas with the metamaterial, an adhesive lacquer which is activated with temperature and/or humidity, and which increase the binding between the element substrate and the surrounding document substrate, thereby making extraction of the security element more difficult.

In some embodiments of the disclosure, the metamaterial is created in register with a feature of the document substrate. For example, in some embodiments of the disclosure, the metamaterial is made in register with a marking on or within the document substrate, such as a mark or other feature printed on the document substrate, or a watermark within the document substrate. In some embodiments of the disclosure, the metamaterial is made in register with a side or edge of the document substrate.

In some embodiments of the disclosure, said part of said conductive layer is removed so as to leave parts of said conductive layer separated from other parts of said conductive layer, forming a regular pattern. That is, the regular pattern can be formed by the conductive parts that are left after removing part of the conductive material.

In some embodiments of the disclosure, said part of said conductive layer is removed so as to form openings in said conductive layer, said openings forming a regular pattern. That is, openings are formed that give rise to said regular pattern. In some embodiments of the disclosure, the openings are formed having a circular or elliptical shape, shapes that are easily achieved using laser light, due to the natural cross section of the laser light beams.

In some embodiments of the disclosure, said regular pattern corresponds to a matrix having a cell size larger than 0.05 mm but smaller than 2 mm, such as smaller than 1 mm. This kind of matrix has been found appropriate for creating a metamaterial having a predetermined response in the THz range.

In some embodiments of the disclosure, the metamaterial is arranged to provide authentication by a characteristic response to radiation in the THz range, preferably to radiation in the range from 25 GHz to 100 THz, more preferably in the range from 100 GHz to 100 THz, such as in the range from 300 GHz to 30 THz or 300 GHz to 3 THz. This kind of radiation easily passes through the bulk of material such as paper, cloth and plastic, wherefore a characteristic response by the metamaterial to this kind of radiation can easily be verified by irradiating a security document, for example, a security document with a plastic or paper document substrate, with this kind of radiation, for example, with radiation in the infrared range.

A second aspect of the disclosure relates to a security document obtained or obtainable with a method as described above.

A third aspect of the disclosure relates to a security document, comprising a document substrate, said document substrate being a paper substrate, said security document further comprising a security element embedded in said document substrate, said security element comprising an element substrate, In accordance with this embodiment of the disclosure, said element substrate is provided with portion of conductive material forming a metamaterial arranged to provide for authentication of the security document. What has been said above about metamaterials applies, mutatis mutandis. In some embodiments of the disclosure, the element substrate is a substrate in the form of a cellulose strip or patch, such as a paper or cellophane strip or patch. This kind of strip or patch can provide for enhanced integration with a paper document substrate, as explained above.

A further aspect of the disclosure relates to a method of authentication of a security document as referred to above, comprising the steps of subjecting the security document to radiation in the THz range, preferably to radiation in the range from 25 GHz to 100 THz, more preferably in the range from 100 GHz to 100 THz, such as in the range from 300 GHz to 30 THz or 300 GHz to 3 THz, and detecting and analysing a response of the security document to said radiation. In some embodiments of the disclosure, EOT (Extraordinary Optical Transmission) or THz-TDS (Time Domain Spectroscopy) can be used to detect the response of the security document to the radiation. Analysis of the response can include analysis of the information content, for example, detection of codes or other data that can identify a security document or its owner, or simply analysis of one or more parameters of the response which, when within pre-determined ranges, confirm that the security document is authentic.

As indicated above, the removal of part of the conductive layer can be carried out using laser light. A laser can be used operating at a wavelength or at wavelengths suitable for removal, by ablation/sublimation, of the conductive material, and the removal can be carried out so that the conductive material, such as metal particles, is sublimated and thus removed, without damage being caused to the paper document substrate or the element substrate. Also, the print on the document substrate can remain intact, that is, no inks or similar are removed.

When the conductive layer includes metal particles to be removed by sublimation, the following laser sources can be preferred to produce the sublimation: Fibre laser; Nd:YAG; Ho:YAG; Er:YAG; Tm:YAG; and CO₂. Of these, Fibre laser, Nd:YAG; and CO₂ are more preferred. For the sublimation of metal particles, wavelengths in the range of 1000-11000 nm are preferably used. The pulses can preferably have a duration in the range of femtoseconds to microseconds, more preferably in the range of nanoseconds to microseconds. The duration influences the thermal impact. The average power of the laser, which influences the sublimation speed, can preferably be in the range of 100-2000 W, more preferably in the range of 125-250 W.

The use of laser light makes it possible not only to create the metamaterial, but also to mark printed security paper with symbols, characters, figures or codes which remain located inside the security paper. Thus, a printed security document can be provided with additional information or security features which cannot be removed, deactivated or modified without destroying or invalidating the document itself.

Besides, the use of laser light to produce the marking makes it possible to obtain a very high accuracy in the position of the marking and in the details of the marking, using commercially available laser equipment. This also reduces the tolerances in the positioning of the marking and allows for an increase in the number of security elements that can be incorporated in the security document.

Depending on the graphical design of the marking, in addition to the possibility to visually detect the marking, it is possible to generate codes with hidden information, only detectable with image inspection devices or specific readers. Such codes include barcodes or dots matrixes.

On the other hand, if the metallic particles which remain in the document after sublimation are also magnetic or, more generically, yielding responses within the electromagnetic wave spectrum when subjected to specific stimuli, it is possible to add an additional property to be detected during an authentication process, using suitable detectors. This allows to even further increase the security level.

### BRIEF DESCRIPTION OF DRAWINGS

To complete the description and in order to provide for a better understanding of the disclosure, a set of drawings is provided. Said drawings form an integral part of the description and illustrate some embodiments of the disclosure, which should not be interpreted as restricting the scope of the disclosure, but just as examples of how the disclosure can be carried out. The drawings comprise the following figures:

FIG. 1 is a schematic perspective view illustrating a document substrate containing an element substrate, in accordance with an embodiment of the disclosure;

FIG. 2 schematically illustrate the insertion of cellulose strips into a paper, during the paper manufacturing stage, in accordance with a possible embodiment of the disclosure;

FIGS. 3A and 3B are schematic perspective views illustrating a process sequence in accordance with an embodiment of the disclosure;

FIGS. 4A-4C are schematic perspective views illustrating a process sequence in accordance with another embodiment of the disclosure; and

FIG. 5 schematically illustrates a system for authentication of a security document in accordance with embodiments of the disclosure.

### DETAILED DESCRIPTION OF DRAWINGS

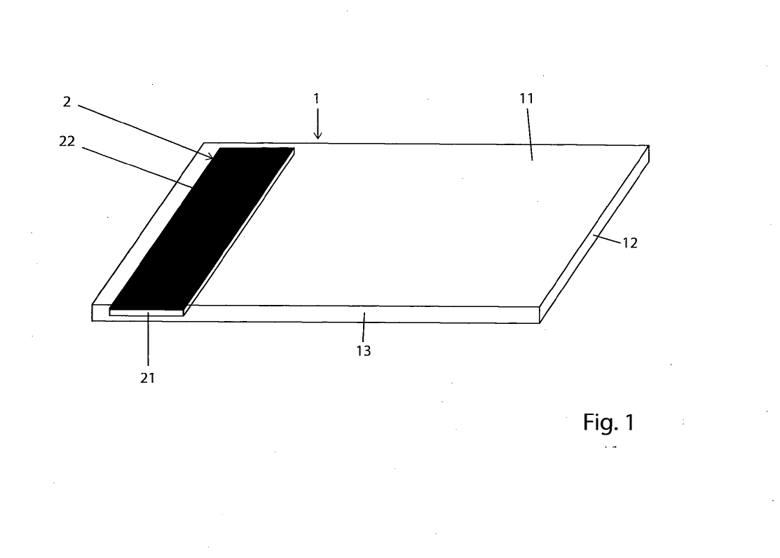

FIG. 1 is a perspective view of a portion of a security document 1, such as a banknote or banknote blank, or a paper to be used to manufacture a passport, or part of a passport blank. The document comprises a document support 11 of paper, and a security element 2 embedded in the paper 11. The security element comprises an element support 21 in the form of a paper strip, covered with a layer of metal particles 22. The security element 2 extends in the machine direction throughout the document support 11, from one of the longer sides 13 to the opposite one of the longer sides of the document support 11, in parallel with the shorter sides 12 of the document support. The document support may be printed, but the print is not shown in FIG. 1, for simplicity. The metal layer can optionally be perforated, such as with microperforations, to enhance capillarity. Also, for example, if the element substrate is a cellophane substrate, advantageously also the substrate is provided with perforations, to enhance capillarity.

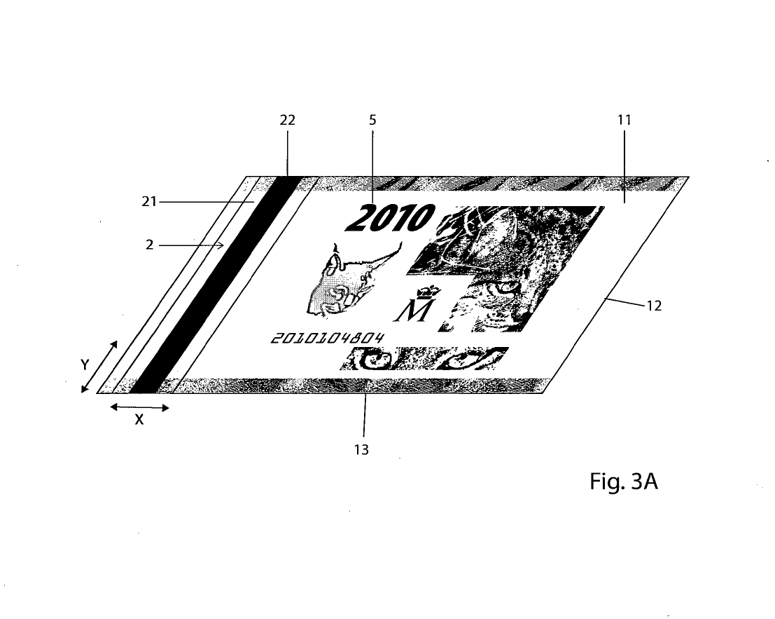

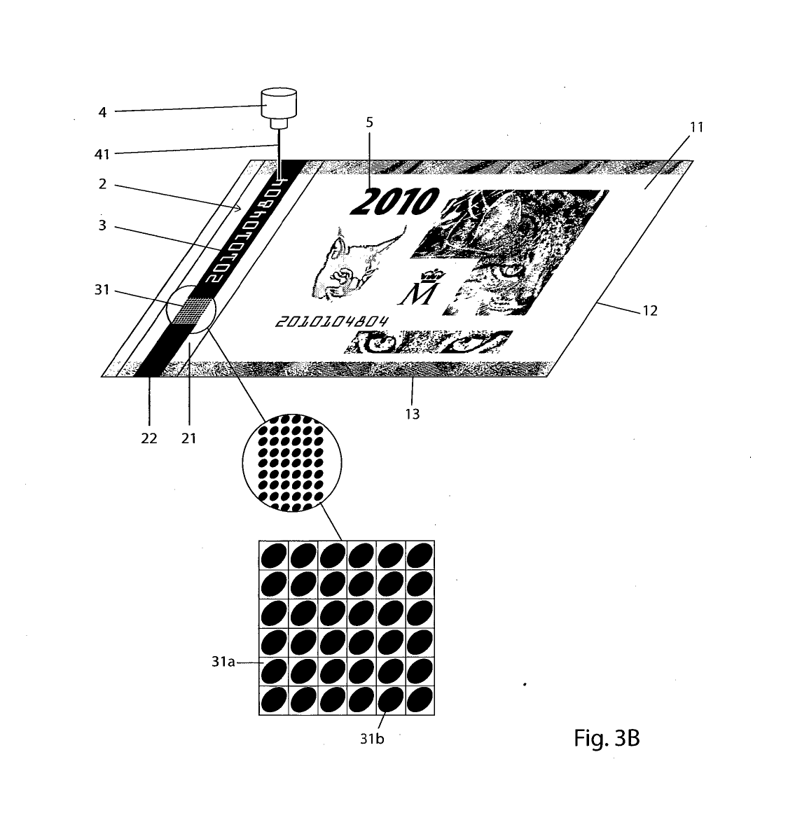

FIG. 3A is a top view of a security document, such as a banknote. The security document substrate 11 is a rectangular sheet having two shorter sides 12 and two longer sides 13. Embedded within the rectangular paper sheet is a security element 2, comprising a cellulose element substrate 21 partially covered with a metal layer 22. The security element has been inserted into the document substrate 11 during the manufacture of the paper sheet. For example, a large paper sheet or web can be manufactured in which several security strips 2 are inserted in parallel, and said larger sheet or web can then be cut to produce the individual document support. Due to the tolerances in the process of insertion of the security strips 12, and due to the tolerances in the cutting, the position of the security element 2 can vary in the X direction, that is, in the so-called cross direction, parallel with the longer sides 13. Thus, the security element as such may not be in perfect register with, for example, the shorter sides 12 or with matter printed on the document substrate, for example, printed symbols 5 (such as digit “2” in FIG. 3A). However, when applying the laser light to create the markings 3 (the numbers shaped by the recesses in the metallic layer 22 of the security element 2) as shown in FIG. 3B, this laser marking can be carried out to make sure that these symbols be in register with, for example, the short side 13 of the document substrate, and/or with the matter 5 printed on the document substrate, or with a watermark within the document substrate, etc., irrespective of a certain misalignment of the security strip 2 as such in the “X” direction, especially as the width of the security strip is large enough to allow for the marking of the numbers even if the security strip is slightly displaced in the “X” direction.

The same applies to the alignment of the marking 3 of the security element in the Y direction, that is, the machine direction: as the addition of the marking 3, that is, the serial number, to the security element 2 takes place after insertion of the security strip 2 into the document substrate 11, it is possible to make sure that the digits of the serial number are placed correctly also in the “Y” direction, that is, in the axial direction of the security strip 2. This can be more difficult to achieve when a pre-marked security thread is inserted into a document substrate.

FIG. 3B schematically illustrates how a laser source 4 is used to generate and direct a beam of laser light 41 towards the document support 11 and the security element 2. The laser light is projected onto the layer of metal particles 22 and sublimates the metal particles along the path scanned by the laser light beam, thereby creating recesses in said layer of metal particles 22. It can be seen how a marking in the form of series of recesses 3 shaped as digits has been established in the security element 2 embedded in the paper of the document support 11. Neither the document support 11 nor the element support 21 have been damaged, so the element support 21 is still embedded in the paper of the security support. The recesses 3 can easily be observed by transparency, but are not readily visible by reflectance, just as in the case with conventional security strips of the kind that, already before insertion into the document substrate, are provided with symbols/characters in the form or recesses in an opaque layer. In accordance with some embodiments of the disclosure, the recesses 3 can be placed in register with the sides of the document support 11, or in register with a feature printed on the surface of the document support, or in register with a watermark within the document support, etc.

In addition to the marking 3, the laser source 4 has also been used to create a metamaterial 31 in the form of an array of base cells 31a each containing an elliptical metal portion 31b, whereby said elliptical metal portions are separated from each other by non-conductive areas where the metal layer 22 has been eliminated using laser light. This metamaterial can be arranged in register with the sides 12, 13 of the document substrate and/or in register with other features of the document substrate such as a printed feature or a watermark, and can have a predetermined response to radiation, such as to radiation in the THz range, thereby serving as an additional means for authentication of the banknote.

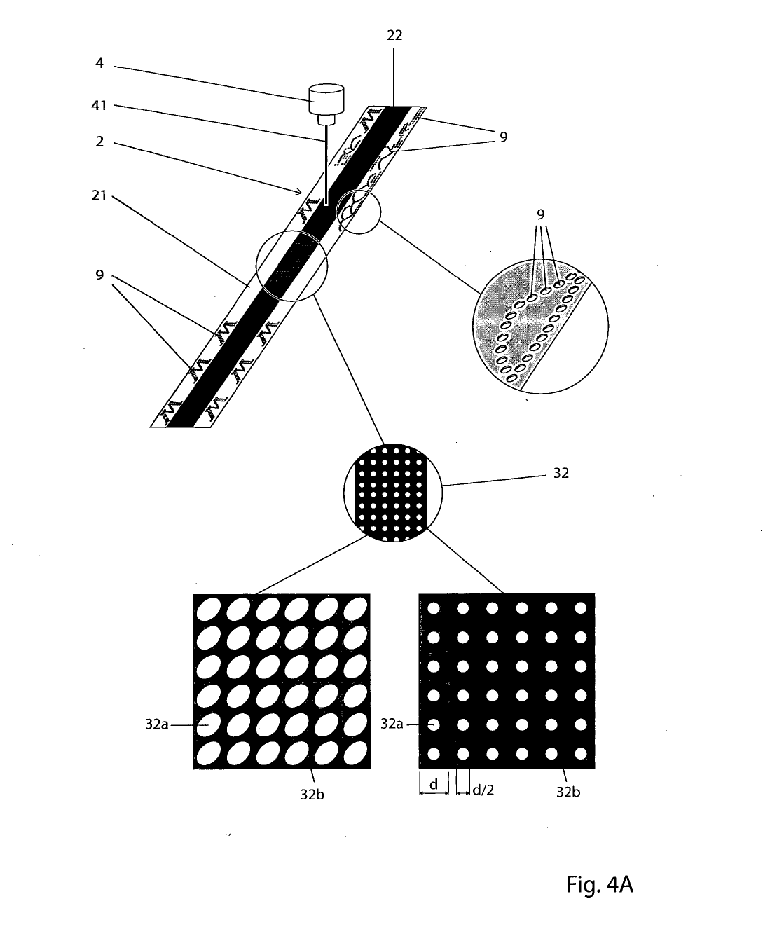

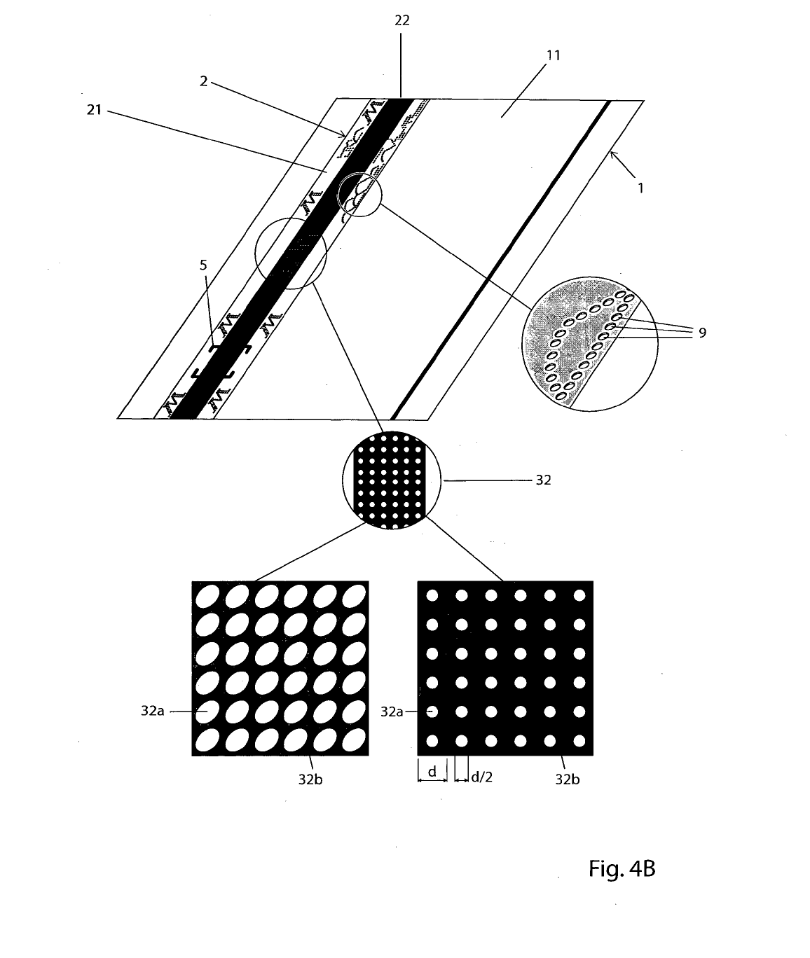

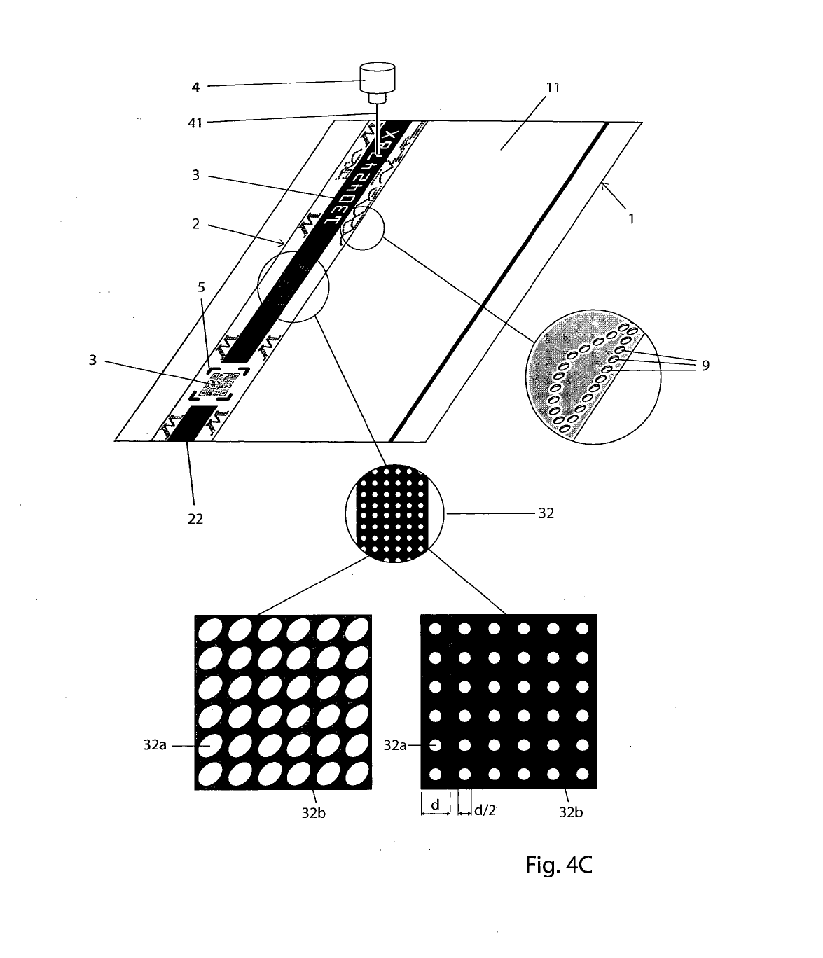

FIGS. 4A-4C illustrate another embodiment of the disclosure. FIG. 4A illustrates a security element 2 comprising a cellophane element substrate 21 with a metal layer 22. The cellophane substrate has been treated with laser light to create a plurality of perforations 9 to enhance capillarity so as to facilitate integration with the document substrate. Also, laser light has been used to create a metamaterial 32, comprising an array of square base cells 32b, each base cell housing a perforation 32a in the metal layer, such as an elliptical perforation or a circular perforation having a diameter d/2, when the base cell has a side with a length d. There perforations perforate the metal layer thus giving rise to a metamaterial having a predetermined response to a frequency in the THz range, and the perforation further perforates the cellophane element substrate thus contributing to enhanced porosity and capillarity,

In FIG. 4B, this security element 2 has been embedded in a paper document substrate 11, and a security document 1 has thus been formed, which in addition includes one or more printed symbols 5. When a passport is to be issued to a specific owner, and the owner's personal and biometric data are known, a QR dot code can be generated on the basis of the biometric data, and this code and other symbols 3 specific to the owner can be introduced in the security element by sublimating part of the remaining metal layer, as illustrated in FIG. 4C, where the QR dot code 3 is placed in register with the symbols 5 printed on the paper document substrate 11. In other embodiments of the disclosure, a metamaterial can be used to customize the document.

The disclosure can, for example, be carried out in accordance with the following examples:

### EXAMPLE 1

Production of a banknote customized with a serial number.

1A.—Manufacture of the security element:

A suitable paper bobbin can be obtained from Papelera de Brandia, S.A., in accordance with the following specifications: basis weight 22 g/m², thickness 48 microns, Bendtsen porosity (×4 sheets) 2600 ml/min, dry tensile strength 28N/15 mm and 17N/15 mm (machine direction and cross direction, respectively).

This bobbin can subsequently be printed in a heliogravure printing machine manufactured by Giave, endowed with a printing cylinder manufactured by Artcyl and engraved by Ziraba. A suitable ink can be obtained from SICPA, with a viscosity of 32 s CP4 and containing aluminium metallic particles. The printing cylinder can be chemically engraved with a 36 lines/cm screen and a 34-micron cell depth with blocks so as to print, on the paper bobbin, 8 mm wide printed longitudinally continuous strips separated in the cross direction so that the distance in the cross direction between the centers of adjacent strips is 18 mm. This can be carried out with a machine speed of 80 m/min, a drying tunnel temperature of 45° C. and a winding tension of 150 N. Under these conditions, a 0.6 micron thick layer can be obtained in the printed area. Once the bobbin has been printed, it can be cut into 18 mm wide strips which can be wound on independent reels.

1B.—Manufacture of the document substrate with incorporation of the security element:

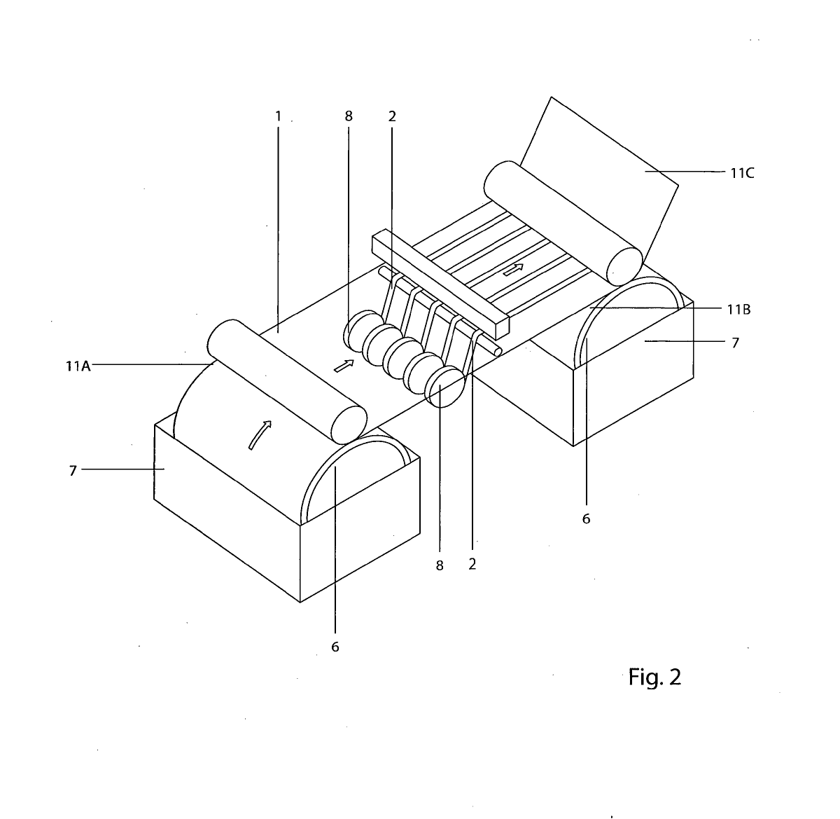

A conventional paper machine with two cylindrical wire meshes 6 as shown in FIG. 2 can be used, together with an aqueous dispersion 7 of bleached and refined cellulose fibres. The paper machine can be adapted to manufacture a two-layer 11A and 11B security paper at a speed of 75 m/min to obtain a paper 110 with the following characteristics: basis weight 90 g/m², thickness 95 microns, opacity 80%. The cellulose strips making up the security elements 2 are embedded between the two layers 11A and 11B, as shown in FIG. 2. The unwinding of the reels 8 with the cellulose strips making up the security elements 2 has to be carried out appropriately to achieve a correct embedding of the security elements 2. For example, the strips can be propelled with 1.75 bar compressed air so as to approach the strips up to 8 mm with respect to one of the two layers of the paper, whereafter contact take place automatically. Once the adhesion of the security element 2 between the two paper layers 11A and 11B has been achieved due to the phenomena of capillarity and transfer of fluids from the cellulose pulp, the tension in the security element strip is maintained at the same unwinding speed as the paper layers 11A and 11B, and with a 0.3 bar propelled air pressure to maintain the strip suspended in the air. Under the described conditions, it is not necessary to microperforate the security element prior to insertion, in order for it to be correctly embedded, as the printed metal strips are not very wide, and as the print does not eliminate the porosity of the paper, so that the strips continue to feature a sufficient capillarity.

The obtained roll of security paper can subsequently be cut longitudinally and transversally in order to obtain paper sheets which can be used to print banknotes. These paper sheets can be configured with 5 cellulose security elements, embedded without increasing the paper thickness where they are embedded, and distanced, for example, 160 mm from each other.

1C—Manufacture of a banknote using the security paper:

The paper sheets can be printed in silkscreen, intaglio, offset, etc. printing machines, and provided with backgrounds, images, numbers and details typical of a banknote design.

Then, they can be subjected to the laser treatment of the disclosure. A Notamark machine can be used, manufactured by the company KBA-Giori, with a two-axis head with a Nd:YAG laser source which emits a 1060 nm pulsed laser light beam with an average power of 125 W and a 0.2 mm spot diameter. Under these conditions, the printed sheets can be processed at a speed of 10,000 sheets per hour and 40 banknotes per sheet. The laser radiation produces a sublimation of the metallic particles contained in the security element, producing a marking 3 in the form of recesses in the metal layer, recesses that correspond to the serial number of each banknote, such as 13 OCR numbers having a height of 2.8, as schematically illustrated in FIG. 3B. These recesses can be observed as lighter portions against a darker background when the banknote is held against a light, that is, when viewed by transparency; the darker background corresponds to the part of the metal particle layer that has not been sublimated by the laser source. The numbers can thus be observed by transparency in clear contrast with the rest of the surrounding 8-mm block on each banknote. As explained above, the numbers can be placed at a specific position; an example of a banknote obtained in this manner is shown on FIG. 3B. The banknote has a shorter side 12 and a longer side 13, and comprises a paper substrate 11 which has been printed with different symbols 5, and which contains, embedded within the substrate, the security strip 2 with the numbers 3 obtained by sublimating the metal layer, as described above. In addition, a metamaterial 31 with base cells 31a housing elliptical metal portions 31b can be created, using the laser light to remove part of the metal layer so as to create a matrix with such base cells, the elliptical metal portions corresponding to the part of the metal layer that has not been eliminated in this area. This metamaterial 31 can serve as a further means of authentication of the banknote.

### EXAMPLE 2

Production of a passport with a number and an internal QR code including biometric data of the owner.

2A.—Manufacture of the security element with metallic particles: The starting material can be a cellophane or cellulose acetate film bobbin manufactured by Coopercel; the film can have a basis weight of 30 g/m² and a thickness of 22 microns. This bobbin can subsequently be metalized on 100% of its surface with aluminium particles in a Leybold Optics ProM 1300 machine at a speed of 12 m/s and a pressure of 4×10⁻⁴ mbar. Under these conditions, a layer thickness with an optical density of 2.1 is obtained. The metallized film can subsequently be microperforated regularly with an Nd:YAG laser source adjusted at a wavelength of 10,000 nm and a power of 250 W, producing circular holes with a diameter of 0.2 mm and placed at a distance of 2 mm from each other, and with a staggered configuration. Further circular or elliptical microperforations can be carried out to establish a metamaterial 32 as illustrated in FIG. 4A, which can contribute both the capillarity and to authentication by providing a predetermined response to radiation, for example, in the THz range. Once metallized and perforated, the bobbin can be cut longitudinally into 18 mm wide strips which can be wound in independent reels.

2B.—Manufacture of the document substrate with incorporation of the security element:

A paper machine as described in Example 1 can be used. The paper machine can be adapted to manufacture a two-layer security paper at a speed of 85 m/min with the following characteristics: basis weight 85 g/m², thickness 90 microns, opacity 80%. The insertion of the security element between the two layers of the paper can be carried out as suggested in FIG. 2. A device for the unwinding of the reels containing each security strip can be used in order to obtain the correct embedding of the security element. The strips can be propelled with 1.50 bar compressed air so as to approach the strips up to 8 mm with respect to one of the two layers of the paper whereafter contact takes place automatically. Once the adhesion of the security element between the two paper layers has been accomplished due to the phenomena of capillarity, transfer of fluids from the cellulose pulp and the dryness of the security element, the tension in the security element can be maintained at the same unwinding speed of the substrate manufacturing speed and with a 0.3 bar propelled air pressure to maintain the strips suspended. The obtained roll of security paper can subsequently be cut longitudinally and transversally in order to obtain the paper sheets out of which the passport blanks can be manufactured. The sheets can be configured with 6 cellulose strips embedded without increasing paper thickness in the area in which they are embedded, and positioned according to the desired layout of the pages of the passport

2C.—Passport manufacture:

The paper sheets obtained in the previous step can be printed in a conventional manner, using silkscreen, intaglio, offset, etc. printing machines, with which the backgrounds, images, numbers and details typical to a passport design can be printed. Passport blanks can be produced and delivered to the authority or organization in charge of issuing the passport.

When a passport is to be issued, and the owner's personal and biometric data are known, a QR dot code can be generated on the basis of the biometric data. This QR dot code can then be stored in the security element by means of an Nd:YAG laser source emitting a 1060 nm laser light beam with 125 W pulses and a 0.2 mm spot diameter, thus sublimating the metallic particles of the security element and thus removing part of the metal layer from the security element 2, thereby leaving a marking 3 in the form of a passport number and said QR dot code within the document substrate 11 of the security document 1, as schematically illustrated in FIG. 4C. Optionally, the QR dot code 3 can be placed in register with symbols 5 printed on the surface of the document support. As an alternative or in addition to the QR dot code, a metamaterial coding could be used to customize the passport with data pertaining to or indicative of its owner.

In the above example, the metamaterial forms part of a security element embedded in a paper document substrate, but in other embodiments of the disclosure, the metamaterial can be embodied in a conductive layer placed on a surface of a document substrate, or in a conductive layer within a multilayer document substrate.

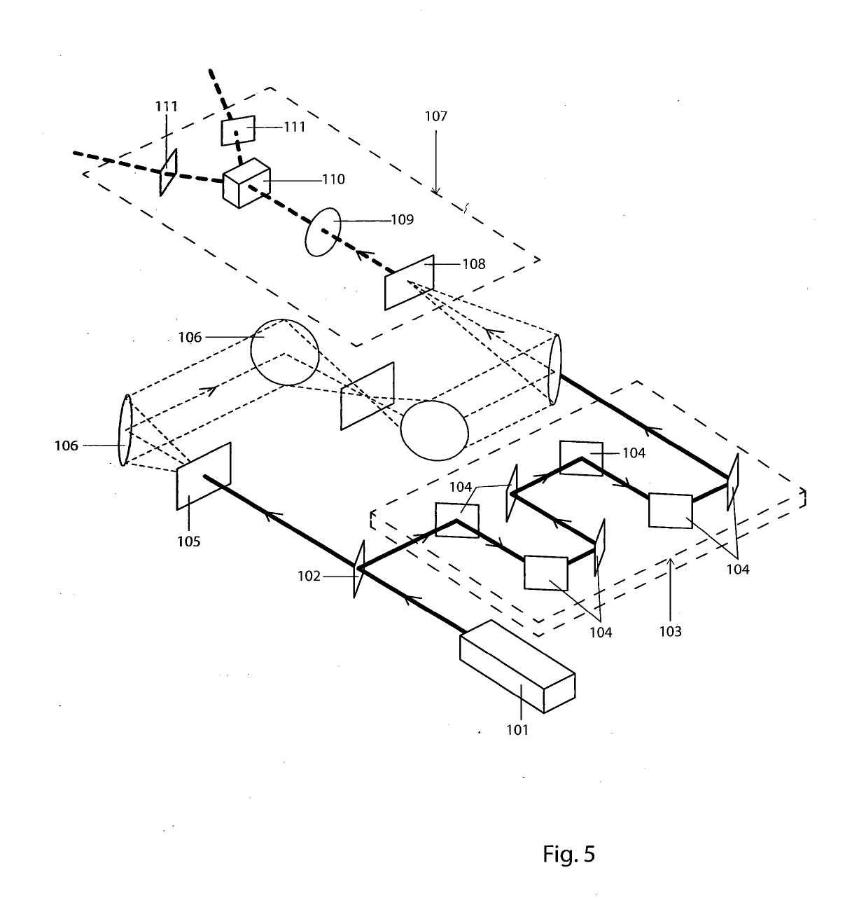

FIG. 5 schematically illustrates a system suitable for the implementation of a method in accordance with some of the embodiments of the disclosure, wherein transmission time-domain THz spectroscopy (TTDTS) is used for authentication of a security document with a metamaterial. A sub-picosecond pulse of electromagnetic radiation is passed through the security document, and the time profile of the pulse is changed compared to the one of a reference pulse. The reference pulse can be either a freely propagating pulse or a pulse transmitted through a medium with known properties. Through an analysis of changes in the complex Fourier spectrum which are introduced by the security document, the spectrum of the refractive index of the material of the security document is obtained, and this spectrum can be determined by the presence of a metamaterial in the security document to be authenticated.

The system comprises a source 101 of light in the THz range, which emits a THz light beam which is split by a beam splitter 102, dividing the beam into two parts. A first part of the beam continues to a delayer device 103 which, using for example a plurality of mirrors 104, modifies the phase of the light delaying it with regard to the other part of the beam.

The other part of the beam arrives, after leaving the beam splitter 102, at a photoconductive switch 105 which transforms the radiation into very short pulses with high intensity. These pulses can be guided by parabolic mirrors 106 until arriving at the security document 1, or at a portion of the security document that may contain the metamaterial. The presence of the metamaterial may, in some embodiments of the disclosure, give rise to an extraordinary optical transmission of the pulses.

On the other hand, the system comprises a detector device 107 which can comprise an optical rectifier 108, a quarter-wave plate 109, a Wollaston prism 110 and a system of balanced photodiodes 111. The rectifier 108 includes an electro-optic crystal (e.g. ZnTe crystal) and is arranged to receive the light that has been transmitted through the security document 1 as well as the light that comes from the delayer device 103.

When passing through the rectifier 108, the initially linearly polarized optical beam gains a small elliptical polarization. This ellipticity is approximately proportional to the electric field applied to the rectifier, i.e. to the THz pulse in every certain moment of time. Because the THz field is much longer than the optical pulse (several ps versus 150 fs), the THz electric field as experienced by the sampling pulse can be considered to be a dc bias field. Therefore, varying the delay between the THz and optical pulse, the whole time profile of the first one can be traced.

The quarte-wave plate 109 is placed behind the rectifier to produce a circular polarization on the incoming optical beam. The Wollaston prism 110 separates this optical beam into two beams which are orthogonally polarized with regard to each other. A differential detector including two balanced photodiodes 111 connected to a preamplifier and a lock-in amplifier (not shown on FIG. 5 for simplicity) is used to sense these two beams. With no THz present, the two components have equal intensity and the differential signal is zero. When the THz field is applied, a nonzero phase difference between the two ortogonally polarized components appears.

In this text, terms generally have the meaning that they commonly have in the art of security documents, and are to be interpreted as they would be interpreted by the person skilled in the art of security documents and security paper. Regarding some of the terms used, a few clarifications are set out below:

“Paper”: in this document, the term “paper” preferably refers to a material in sheet form having a basis weight of less than 250 g/m² and comprising more than 50% by weight of cellulose fibres.

“Security document”: The term “security document” refers to a document having particular characteristics which ensure its origin and authenticity. Security documents include documents used by public administrations and public organizations, as well as those used in the private sector, and which contain identification, authentication or anti-forgery means or devices. Security documents include identification documents (such as identification cards, passports, passes and the like) and value documents (such as bills, cheques, stamps, certificates and the like). A security document can be in the form of a security paper, an identification document, a banknote, a cheque, a stamp or a stamp-impressed paper, a label and a ticket. Sometimes, the term “security article” can be used to more generally include not only security documents but also objects that are not “documents” as such but that are provided with security means to guarantee their authenticity. In the present text, the expression “security document” should be understood in a broad sense, that is, not only as a “finished” document held by a final user, but also as encompassing intermediate products, such as blanks from which a final document can be produced, for example, a blank for producing a passport, said blank comprising the document substrate and, within it, the security element.

“Security element”: the term “security element” relates to an element which is integrated into or applied to a security document or article for the purpose of authenticating it. The security element can be integrated into the substrate of a document, such as into a paper substrate, such as the paper substrate of a banknote or a paper substrate making up one or more pages of a passport or other identity document; this is frequently the case with security elements in the form of security threads, strips, ribbons, bands, patches, security fibres, watermarks, and elements producing tactile effects. Alternatively, the security element can be applied to the surface of the substrate of the security document; this is often the case with security elements in the form of holograms added to banknotes and credit cards, security inks, plastic sheets or other commonly used elements.

“Substrate of the security element” or “element substrate”: Sometimes the material which provides a detectable or measurable security feature, such as an ink, a metal layer, etc., needs a carrier. The expression “substrate of the security element” or “element substrate” relates to said carrier, basically, the base material of which said element is made up. Frequently, the element substrate has a substantially laminar shape, such as the shape of a band or patch, although element substrates can also be fibrillar, in the shape of microparticles or in liquid dispersions such as inks. For example, security threads and holographic strips are usually manufactured using synthetic polymeric substrates, such as polyester or polypropylene substrates. It is customary to use cellulose substrates, in the form of paper substrates (basically obtained by mechanical treatment of the cellulose fibres of natural origin) or cellophane substrates (basically obtained by chemical treatment of said natural cellulose fibres).

“Substrate of a document” or “document substrate”: This term typically relates to the support used for the printing or manufacture of the security document, which can contain security features. For example, in the context of banknotes, passports, and other value or identity documents, the document substrate is frequently a paper substrate.

“Thread”, “band”, “ribbon” and “strip” generally refer to substantially elongate elements, for example, of the type frequently arranged extending throughout the document substrate, from one side or edge to another side or edge, frequently the opposite side or edge. The term “thread” is not intended to imply any limitation in what regards the cross sectional shape of the element, whereas the terms “band”, “ribbon” and “strip” are generally intended to imply a substantially flat shape, that is, with a cross section being substantially larger in one direction than in the perpendicular direction.

“Sublimation”: This term relates to a physical process in virtue of which a material changes to gas state from solid state without going through liquid state. In the context of this text, it applies to sublimation of material present in and/or on a security element substrate, such as metallic particles present in and/or on a the security element substrate, such as fixed on its surface by means of vacuum printing or metallization techniques.

“Customization”: In the present text, “customization” of a security document relates to a certain stage of the manufacturing process of a security document in virtue of which the security document is endowed with a characteristic or feature which makes it original and unique compared to other documents of the same kind. Providing a passport or healthcare card with user identification data, or providing a banknote or cheque with a number, are examples of customization. The customization can involve the addition of a further security feature, for example, when the addition of a customization feature such as the number of a banknote is carried out in a way that involves a technical difficulty, whereby the presence of the customization feature helps to guarantee the authenticity of the document.

“In register”: positioning in register implies that one item is positioned in a defined position in relation to another item. For example, a security element or a feature of a security element can be positioned in register with, for example, a feature of a substrate into which the security element is inserted, for example, in relation to an edge of the substrate, or in relation to a mark on or in the substrate, such as a printed mark on the surface of the substrate, or a watermark in the substrate. Since industrial processes always require tolerances, placement of one item in register with another item can render forgery more difficult. Also, the reduction of tolerances also makes it possible to increase the number of security elements that can be included in a security document, thus making it even more difficult to counterfeit the document.

“Marking”: A “marking” is understood to include one or more marks, and a detectable marking can serve as a security feature and/or for the customization of a document. For example, a marking can comprise one or more symbols, such as letters, numbers or other symbols, or one or more patterns. Thus, a marking can, for example, include a serial number of a banknote or passport, and/or the name of an owner of an identity document, or an image or coded image of the owner, etc.

“Metamaterial”: A metamaterial is generally understood to be an artificial medium structured on a size scale smaller than wavelength of an external stimulus. In the present text, metamaterial is preferably understood as a material that features a characteristic response to radiation in the THz range, preferably to radiation in the range from 25 GHz to 100 THz, more preferably in the range from 100 GHz to 100 THz, such as in the range from 300 GHz to 30 THz or 300 GHz to 3 THz, or to radiation having a wavelength in the range of 0.05-1 mm, preferably at one or more frequencies within said ranges. Preferably, the metamaterial is understood to be a pattern of a conductive material, such as a pattern of conductive material in which regularly distributed openings have been made, or a pattern comprising regularly distributed parts of the conductive material on a substrate. The openings or the conductive parts that form the pattern can be shaped as circles, ellipses, squares, rectangles, polygons, and/or other arbitrary shapes, such as symbols, such as letters, stars, etc. The largest dimension of said openings or conductive parts (such as the diameter of a circular opening or a circular conductive part, or the diagonal of a square or rectangle) is preferably less than 1.00 mm, such as between 0.05 and 1.00 mm, and the spacing between the centres of adjacent openings/conductive parts is preferably not less than said largest dimension and not more than twice said largest dimension. The openings or the conductive parts are preferably arranged in rows and columns, forming a matrix. The conductive material in which the openings are formed, or the conductive parts of the metamaterial, preferably have a thickness of less than 5 μm. When the openings or conductive parts are arranged in rows and columns, the term cell size refers to the average size of said columns and rows or to the average distance between the centers of said openings or of the conductive parts in the columns and rows. The rows and columns can be perpendicular to each other or at other angles to each other.

In the figures, the dimensions are not intended to be in scale with typical real-life embodiments of the disclosure. Typically, the width/thickness ratio of the security element will be much larger, as the strips are typically very thin, for example, in the order of 50 microns, and rather wide, for example, having a width in the order of 10-35 mm.

In this text, the term “comprises” and its derivations (such as “comprising”, etc.) should not be understood in an excluding sense, that is, these terms should not be interpreted as excluding the possibility that what is described and defined may include further elements, steps, etc.

In this present text, whenever intervals or ranges are given, the end points are included, unless the contrary is indicated.

On the other hand, the disclosure is not limited to the specific embodiment(s) described herein, but also encompasses any variations that may be considered by any person skilled in the art (for example, as regards the choice of materials, dimensions, components, configuration, etc.), within the general scope of the disclosure.

1. A method of providing a security document with a security feature, including the following steps: providing a conductive layer, removing part of said conductive layer to convert at least a portion of said conductive layer into a metamaterial selected to provide for authentication of the security document, and wherein said step of removing part of said conductive layer further includes the step of leaving parts of said conductive layer separated from other parts of said conductive layer, or removing said part of said conductive layer so as to form through holes in said conductive layer.

2. The method according to claim 1, wherein said part of said conductive layer is removed using laser light.

3. The method according to claim 1, wherein said part of said conductive layer is removed mechanically.

4. The method according to claim 1, wherein said part of said conductive layer is removed chemically.

5. The method according to claim 1, wherein said conductive layer is applied to a security element substrate, and wherein said security element substrate is thereafter embedded in a security document substrate.

6. The method according to claim 5, wherein said part of said conductive layer is removed after said security element substrate has been embedded in said security document substrate.

7. The method according to claim 5, wherein said part of said conductive layer is removed before said security element substrate is embedded in said security document substrate.

8. The method according to claim 5, wherein said security element substrate comprises a strip or a patch of paper, cellophane, polyester, propylene, or polycarbonate.

9. The method according to claim 1, wherein said conductive layer is applied onto a security document substrate, whereafter said part of said conductive layer is removed.

10. The method according to claim 5, wherein said security document substrate is a paper substrate.

11. The method according to claim 1, wherein said part of said conductive layer is removed so as to leave parts of said conductive layer separated from other parts of said conductive layer, forming a regular pattern.

12. The method according to claim 1, wherein said part of said conductive layer is removed so as to form a plurality of openings in said conductive layer, said plurality of openings forming a regular pattern.

13. The method according to claim 11, wherein said regular pattern corresponds to a matrix having a cell size larger than 0.05 mm but smaller than 2 mm.

14. The method according to claim 1, wherein said metamaterial is arranged to provide authentication by a response to radiation in the THz range from 25 GHz to 100 THz.

15. A security document obtained or obtainable with a method according to claim 1.

16. A security document, comprising a document substrate, said document substrate being a paper substrate, said security document further comprising a security element embedded in said document substrate, said security element comprising an element substrate, wherein said element substrate is provided with a portion of conductive material forming a metamaterial arranged to provide for authentication of the security document and
wherein said element substrate is a substrate in the form of a cellulose strip or patch, such as a paper or cellophane strip or patch.

17. (canceled)

18. The method of authentication of a security document obtained or obtainable with a method according to claim 1, comprising the steps of subjecting the security document to radiation in the THz range in the range from 25 GHz to 100 THz, and detecting and analysing a response of the security document to said radiation.
